(19) United States
(12) Patent Application Publication
(10) Pub. No.: US 2013/0169566 A1
(43) Pub. Date: Jul. 4, 2013

(54) METHOD, SYSTEM AND APPARATUS FOR DATA MANIPULATION

(71) Applicant: Humberto A. VARGAS, Ashburn, VA (US)

(72) Inventor: Humberto A. VARGAS, Ashburn, VA (US)

(21) Appl. No.: 13/706,549

(22) Filed: Dec. 6, 2012

Related U.S. Application Data
(60) Provisional application No. 61/581,428, filed on Dec. 29, 2011.

(51) Int. Cl. G06F 3/041

(52) U.S. Cl. CPC G06F 3/041
USPC 345/173

(57) ABSTRACT

According to at least one exemplary embodiment, a system and method of inputting data may be described. One such method can include running a software application on a device with a touch screen; generating a swipe pattern through interaction of a user with the touch screen; saving the swipe pattern; associating data with the swipe pattern; and inputting the data into a field when the swipe pattern is made.

### CROSS-REFERENCE TO RELATED APPLICATIONS

This application claims priority to U.S. Provisional Patent Application No. 61/581,428, filed Dec. 29, 2011, and entitled Method, System And Apparatus For Data Manipulation, the entire contents of which are hereby incorporated by reference.

### BACKGROUND

Due to advancements in technology, Internet-based applications and systems have become integral to almost every aspect of personal and businesses life. One reason for this development is that the recent improvements in mobile technology have provided users with sophisticated devices which offer a diverse array of functionality and faster internet connections. Thus, mobile devices are now frequently used to access the internet in order to accomplish a wide variety of tasks. However, even a simple task, such as accessing a calendar, may utilize a username and password in order to identify the user. While mobile devices have incorporated improved speed and functionality, many of these devices are also made as small as possible in order to fit comfortably in a user's pocket. This, in turn, has forced users to become extremely accurate when attempting to touch a digital keyboard or particular portion of a display screen. Thus, it is increasingly difficult to enter a password, username or other identifying information into Internet-based forms or fields.

In order to ease the task of data entry, many systems and methods for automatically filling the data entry fields have been developed. However, many of these systems and methods require a user to begin typing, touch a small portion of the screen corresponding to a specific field, or some combination thereof. Further, many of the autofill solutions require a user to manipulate various menus in order to utilize the automatic data entry.

### SUMMARY

According to at least one exemplary embodiment, a system and method of inputting data may be described. One such method can include running a software application on a device with a touch screen; generating a swipe pattern through interaction of a user with the touch screen; saving the swipe pattern; associating data with the swipe pattern; and inputting the data into a field when the swipe pattern is made.

A further exemplary embodiment can describe another method for inputting data. This method can include inputting data into an application on a device; associating the data with a website and a pattern in the application on the device; browsing to a recognized website on the device; prompting the input of a pattern on a display on the device; inputting a pattern into the device; comparing the inputted pattern with at least one known pattern; and populating data fields upon the successful input of a pattern.

In still another exemplary embodiment, a system for inputting data onto a website can be described. This system can include a smart phone having a process and memory; an application with an interface for inputting data, associates data with at least one of a plurality of patterns, and facilitates storage of the data; and a website with data input fields that is compatible with the application, wherein the application recognizes a website, the website provides a prompt to input a pattern, the application compares an inputted pattern with the plurality of patterns stored by the application and inputs the data associated with at least one of the plurality of patterns upon a successful comparison of the inputted pattern with the plurality of patterns stored by the application.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 is a diagram of an exemplary computer system;

FIG. 2 is a diagram of an exemplary embodiment of a swiping system;

FIG. 3 is a diagram of an exemplary embodiment configured for an Android Operating System;

FIG. 4 is a flow chart of exemplary operational steps for utilizing the swipe in system.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

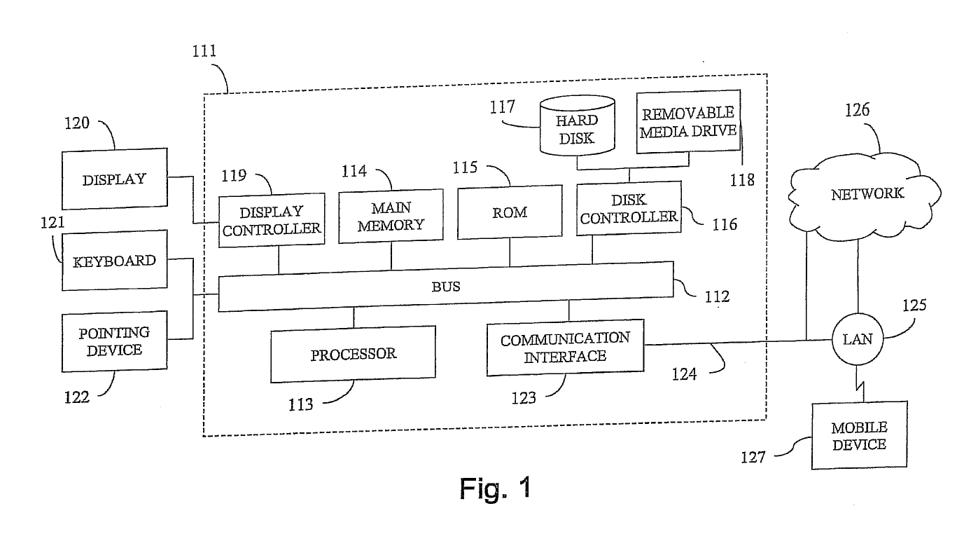

Generally referring to FIGS. 1-4, a system and method for automatically inputting data into various fields may be disclosed. The system may be compatible with any desired browser, such as Firefox, Microsoft Internet Explorer, Safari, Google Chrome, or Opera, and with any desired operating system, for example, but not limited to, Windows, OSX, iOS, Android, or Windows Mobile, such that it may run on any desired computing device, such as various mobile phones, personal digital assistants (PDAs), tablets and personal computers. The system and method may be included in a mobile application, which may be available via marketplace platforms such as the Apple App Store and Google Android Market. Generally, the system and methods may allow various data entry to fields to be automatically filled with data relating to a particular user in response to a touch based gesture.

FIG. 1 illustrates an exemplary computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the main memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission.

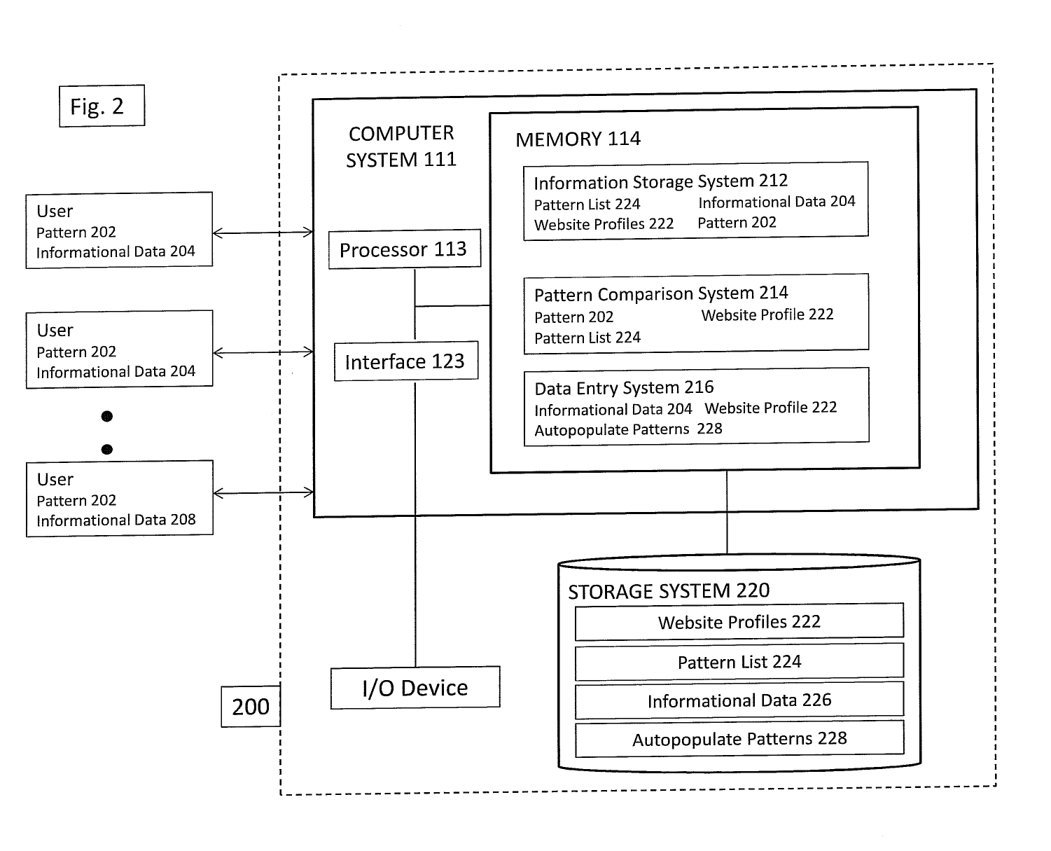

According to at least one exemplary embodiment, FIG. 2 may depict a system 200 that allows for data input and manipulation. System 200 may allow users to input informational data 202 relating to any desired information, such as biographic data, usernames, passwords and preferences, such that system 200 may automatically fill forms and fields, such as Internet-based login information, that utilize data inputs. Further, system 200 may allow users to open, access or load programs, applications, or websites, any of which may be security enabled. System 200 may allow users to utilize system 200 with a simple gesture, movement or motion, such as touch-based gestures or “swipes” on a touch-screen device. In one exemplary embodiment, if a recognized pattern is drawn on a touch screen device while a user is viewing or accessing a website (or any other interface) with data entry fields, system 200 may automatically input appropriate data or data associated with that pattern into any corresponding data entry fields. Although many of the embodiments are described in English, system 200 may function in any desired language, such as, but not limited to, English, Spanish, Portuguese, Mandarin and Indian based dialects.

As depicted in the exemplary embodiment of FIG. 2, system 200 may include information storage system 212, pattern comparison system 214 and data entry system 216. In one exemplary embodiment, information storage system 212 may be configured to receive data input by any number of users which may relate to a pattern list 224 or informational data 204. Information storage system 212 may interrelate pattern list 224, informational data 204, and website profiles 222. For example, a specific pattern 202 from pattern list 224 may be associated with a particular website profile 222, which may in turn be associated with particular informational data 204. Thus, if a particular website profile 222 is encountered, a user may enter a particular pattern 202 corresponding to pattern contained within pattern list 224 in order to automatically populate the fields contained within the website profile 222 with the appropriate informational data 204.

Informational data 204 may relate to any desired information, such as any desired personal or business information. For example, informational data 204 may include usernames and passwords for any desired web page, such as an online banking website, gaming website or email hosting website. In some exemplary embodiments, informational data 204 may also relate to security information, such as challenge-response systems like Completely Automated Public Turing test to tell Computers and Humans Apart (CAPTCHA). Additionally, informational data 204 may include data related to other Internet-based forms, including, but not limited to, credit card information, user preferences, biographical data, such as a user's address, birthday, and phone number, or some combination thereof.

Informational data 204 may be associated with a particular website profile 222, or alternatively, may be used as “global” information for any website. For example, a user may associate different usernames and passwords with various website profiles 222 but associate the same “First Name” information, such as “John,” with any encountered website profile 222. Thus, if system 200 determines that a data entry filed included or incorporated on a website profile requests a first name, system 200 may automatically place “John” into this field. If, instead, various informational data 204 is associated with one data entry field, system 200 may determine the appropriate informational data based on various other criteria, such as the website profiles 222 or pattern 202.

Website profiles 222 may include any desired data relating to a website. For example, system may retain a cached page of any desired website in order to retain information from this web page. System 200 may create website profiles for any desired website. In some exemplary embodiments, website profile 222 may include a URL and may designate or otherwise denote any data entry fields which are contained within the particular website. Thus, if a user visits the particular website again, system 200 may recognize the website, as well as the data entry fields which may utilize informational data 204.

Still referring to exemplary FIG. 2, a user may input pattern 202 into system 200. Pattern 202 may be any desired input, including gesture-based inputs, such as a series of touch-based swipes around the border or any other location on a touchscreen of the mobile device. In one exemplary embodiment, touch based gestures may simply be made anywhere on the face of the display. However, in other exemplary embodiments, a user may be presented with a template or image on which to enter pattern 202. A user may be presented with any desired template, including a variety of graphic templates developed from images which may be stored within system 200, for example in a library. For example, if a user encounters a website which utilizes a username and login, the user may be presented with a matrix of dots on which they can input pattern 202. In this exemplary embodiment, pattern 202 may be a line drawn through a particular series of dots included within the matrix.

Alternatively, a user may be presented with a picture, for example a picture of a basketball team's logo or any other desired picture, and may be prompted to trace the border of the logo. In some exemplary embodiments, different graphics may be associated with different website profiles 222, such that a user may be presented with a first graphic at first web site profile 222 and a second graphic at a second website profile 222. System 200 may include a custom picture library of icons and graphics. Some of the icons in this library may be “swipe icons,” such that a user may desire to connect certain portions of an icon in order to create a pattern 202. In some exemplary embodiments, this library may be supplemented with graphics and icons from any desired source. For example, a user may add graphics or icons found on the Internet, upload photos or images, take photographs or screen shots with the device on which system 200 is implemented on, or some combination thereof in order to supplement or complete the graphics library. In some exemplary embodiments, system 200 may convert uploaded or inputted images into swipe icons by adding certain reference points within the graphic or image. Additionally, the graphics library may also include custom graphics templates for a user interface module, which may be presented to enter informational data 204 or adjust system 200's settings.

A user may input data, such as pattern 202 and informational data 204, into system 200 through any of a variety of manners. In some exemplary embodiments, users may utilize input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a stylus for communicating direction information and command selections to the processor 113 and for controlling cursor movement on the display 120. Through these input devices, a user may, for example, input particular informational data 204 through keyboard 121 and use a pointing device 122 to select a pattern 202 to be associated with the informational data 204. For example, a user may create a pattern with a touch-based gesture or a pointing device 122 which may be input into system 200 and subsequently associated with various website profiles 222, and informational data 204 which may have been input through an external or touch screen keyboard 121. In other exemplary embodiments, a user may select data, such as a pattern 202 or informational data 204, from a desired menu which may be configured in any desired manner.

Any informational data 204 or patterns 202 which are input into system 200 may be stored in a database. The database may be an encrypted database, which may retain usernames, passwords, URL addresses, patterns, or some combination thereof, such that the informational data input into system 200 may be securely stored. The database may also be, or include, a relational database such that informational data 204, website profiles 222 and pattern lists 224 may be interrelated. The database may also include a database management system, such as SQLite or SQL, or any other database management system that may be known or desired.

Additionally, system 200 may store or create security measures which may be presented to a user attempting to access a particular website, software application or network, such as a Virtual Private Network (VPN). In these exemplary embodiments, a user may need to input a variable code or password or may be presented with a CAPTCHA or other challenge-response test in order to authenticate that the user is in fact human or otherwise authorized to be accessing the particular website, application or program. For example, if a user attempts to access a VPN, system 200 may present a pattern from pattern list 224 and may request a user to reproduce the presented pattern for authentication purposes. In other exemplary embodiments, a user may be required to input a specific pattern 202 which may correlate to a particular pattern from pattern list 224 which may not be presented to a user. Thus, system 200 may serve as an additional layer of security to any desired information, program or application.

Still referring to the exemplary embodiment depicted in FIG. 2, system 200 may include a pattern comparison system 214. Pattern comparison system may allow system 200 to compare user input patterns, such as pattern 202, with patterns contained within pattern list 224. If a user enters a pattern 202 at a particular website, pattern comparison system 214 may determine if pattern 202 matches the particular pattern from pattern list 224 associated with that particular website profile 222. A comparison may be made based on size, location, shape or any other desired criteria. In some exemplary embodiments, the location of a pattern may not be relevant if the shape and size are identical, while in other exemplary embodiments, the location may be the only criteria used to determine if a match is present.

System 200 may further include data entry system 216. Data entry system 216 may automatically populate any desired fields which appear on any website profile 222 in accordance with autopopulate patterns 228, which may include any methods known in the art. If a match is found, system 200 may automatically populate any data entry fields which correlate to informational data 204 which may be associated with the particular website profile 222 being accessed. Alternatively, if global informational data 204 had been entered, system 200 may automatically populate any corresponding fields with the appropriate informational data 204.

In some exemplary embodiments, system 200 may, upon receiving the appropriate pattern 202, automatically populate any data entry fields contained within a website currently being displayed. Alternatively, a user may input pattern 202 and system 200 may only automatically populate certain data entry fields. For example, if a user only desires informational data 204 pertaining to a certain credit card, but not to a shipping address, to be automatically filled, the user may enter a specific pattern 204 associated only with credit card data, such that only this information is automatically input into that particular website.

In other exemplary embodiments, system 200 may open, unlock, or start a particular program, software application, or some combination thereof, if a match is found. In such an exemplary embodiment, any computing device, such as a mobile phone, may receive a pattern 202 and subsequently open or unlock any desired application or program. A specific pattern 202 may be associated with specific programs or applications, or alternatively, a pattern 202 may be associated with multiple programs or applications installed or resident on an electronic device. In some embodiments, a particular pattern 202 may identify a particular user, such that data entry system 216 may subsequently input or load any data associated with that user into the program or application as it opens. For example, if a user inputs a pattern 202 corresponding with both an email application and a first user, the first user's email inbox may be subsequently displayed on a device. In some embodiments, system 200 may provide access to all software or applications residing on a user's device, including security enabled software and applications.

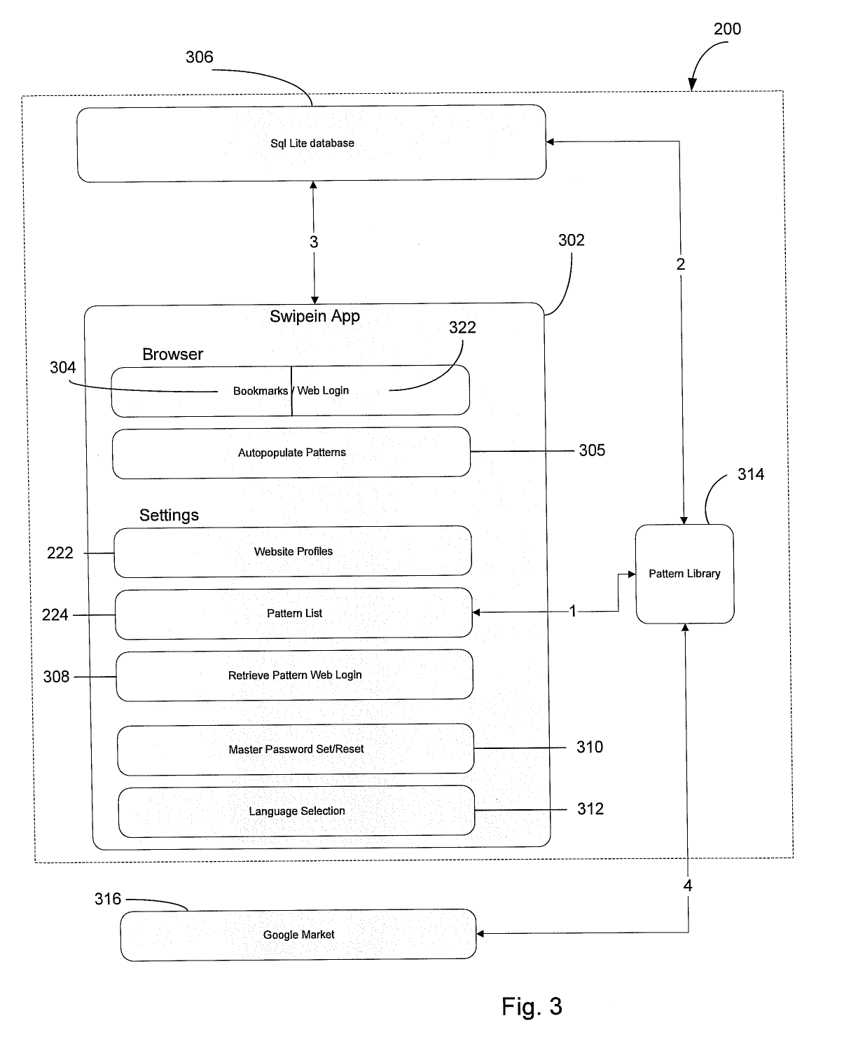

Now referring to FIG. 3, an exemplary embodiment of system 200 configured for use with an Android Operating system may be shown. It should be noted, however, that system 200 may be utilized in similar manners with any other operating system, as desired. System 200 may be configured as an application 302 which may be installed on an Android Operating system and may interact with any browser, program or application functioning on this operating system. For example, if the browser used on the Android system stores or retains bookmarks 304 or web logins 322, system 200 may utilize these logins and bookmarks to serve as informational data 204 and website profiles 222, respectively. Similarly, system 200 may utilize any database and database management system included in or utilized by the Operating System of the device it is installed on. For example, in the exemplary embodiment of FIG. 3, system 200 may utilize the Sql Lite Database 306 in accordance with methods known in the art. Further, if system 200 utilizes application 302, it may be appreciated that application 302 may be presented in any of a variety of styles and layouts, as desired. Further, use and navigation of application 302 may be accomplished in any known manner.

Still referring to FIG. 3, in some exemplary embodiments, system 200 may be delivered to computing devices through marketplace platforms 316 such as, but not limited to, Apple App Store, Google Android Market and other App marketing systems. Additionally, software updates and add-on features may also be delivered from similar marketplace platforms. In other exemplary embodiments, updates to system 200 may be transferred and stored through cloud technology, as is known. In this manner, informational data 204, and patterns 202 associated therewith, may be entered on a mobile device and transferred to a personal computer, such that the user may simply enter the particular pattern 202 on the personal computer to quickly login to a particular website on the personal computer.

In still further exemplary embodiments, and still referring to FIG. 3, application 302 can provide for further functionality, customizability or ease of use or access. For example, the browser of application 302 can allow for autopopulation of patterns 305. The autopopulation of patterns 305 may allow for any of a variety of patterns to be implemented and a user may associate a function or data with any of those patterns.

In still other exemplary embodiments, application 302 can have any of a variety of settings that may be adjusted or customized. In addition to website profiles 222 and pattern list 224, which may be drawn from pattern library 314, a number of other items can be set or changed, as desired. For example, a user may retrieve a pattern web login 308, utilize a master password set/reset 310 or choose any desired language 312. Each of these items may be utilized in any known manner, as desired.

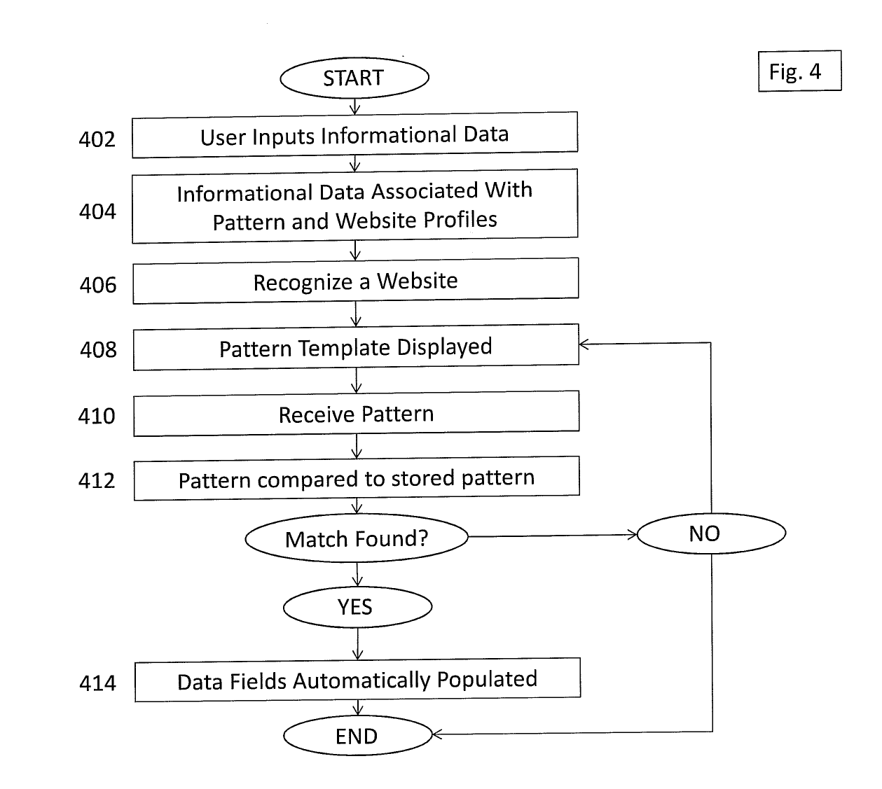

According to at least one exemplary embodiment, a method of utilizing system 200, may be depicted in exemplary FIG. 4. In step 402, a user may input informational data 204. As mentioned, a user may input informational data 204 by using traditional input devices, such as a pointing device, stylus, keyboard or touch screen, selecting the appropriate informational data 204 from a variety of menus, uploading the information, or some combination thereof. Alternatively, if the appropriate informational data 204 is stored within a browser, system 200 may extract this data from the browser. Once informational data is 204 is received or collected, system 200 may, in step 404, interrelate this data with various website profiles 222 and patterns 202. System 200 may associate the correct informational data 204 with a specific pattern 202 and the appropriate fields on various website profiles 222, such that all data entry fields on a particular website are properly filled in when system 200 receives a specific pattern 202.

After steps 402 and 404 are complete, system 200 may, in step 406, monitor browser activity in order to determine if a user has accessed a website corresponding to a website profile 222. In other exemplary embodiments, system 200 may monitor any desired activity on a device, such that step 406 may relate to an application use instead of website access. Once system 200 recognizes a particular action, it may, in step 408, display a specific graphic, such as an icon or swipe icon. This graphic may allow a user to enter a pattern 202, which system 200 may receive in step 410 and subsequently compare, in step 412, to a pattern associated with the website profile 222 currently being accessed.

If a match is found, any data entry fields found on the website may, in step 414, be automatically populated with the corresponding informational data 204. If system 200 is configured as a security measure or system, the corresponding informational data may simply be a security clearance to the website, program, application or network, such that the website, program, application or network may be accessed. If no match is found in step 412, system 200 may repeat step 408, 410, and 412 and, once again, show a pattern template, receive a pattern 202 and compare it to the pattern associated with the current website. In some exemplary embodiments, system 200 may repeat steps 408, 410, and 412 a predetermined number of times in response to non-match. If a match is not made over the course of the predetermined number of iterations, the security system may lock the user or data associated with pattern or patterns. Alternatively, steps 408-412 may be repeated until a match is found.

In still another exemplary embodiment, a swiping system may be utilized to provide immediate communication or data transmission capabilities. For example, a swiping system may be utilized to call an emergency number or otherwise communicate data that may be relevant in an emergency situation. In one such embodiment, a user may set or designate a pattern which may be swiped and associate some type of action with the swipe. A user may designate any of a variety of actions with a swipe. For example, a user can designate a swiping pattern such that after the pattern is swiped, an emergency number, such as 911, may be dialed. In a further exemplary embodiment, after performing the designated swipe, other features of a smart phone, may be activated. These can include the activation of the phones global positioning system (GPS) so that the location of the phone may be determined or any other features that may be relevant to determining the location or status of a user of the phone.

In a further exemplary embodiment, swiping associated with contacting an emergency may be utilized in situations where it may be difficult or imprudent for a user to call a number in a typical, substantially conspicuous manner. For example if a young person is kidnapped, they may know that they can perform an emergency swipe while keeping their phone in a pocket. Similarly, if someone is in a location where a crime is being committed, such as a bank during a bank robbery or at a school where there is a shooting, they may be unable to remove their phone and report the situation. However, if they can swipe a predetermined pattern on their phone while it remains out of sight, for example while the phone remains in their pocket, that person may be able to successfully contact authorities or emergency personnel, or otherwise send a distress signal.

In still further exemplary embodiments, a swipe, such as that associated with an emergency call or contact above, may have any of a variety of settings associated with it. After a user designates a swiping pattern, they may then associate any desired actions with that swiping pattern. In one example, it may be the dialing of 911 or some other emergency contact number. In further example, a prerecorded message may then be played to a party who answers the call. In other embodiments, a user can designate that the phone be silenced when such a swipe takes place in order to prevent others from knowing that a call has been made.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for inputting data, comprising:
running a software application on a device with a touch screen;
generating a swipe pattern through interaction of a user with the touch screen;
saving the swipe pattern;
associating data with the swipe pattern; and
inputting the data into a field when the swipe pattern is made.

2. The method of claim 1, wherein the data is text data.

3. The method of claim 1, wherein the device is one of a mobile phone and a tablet computer.

4. The method of claim 1, wherein the data is emergency calling data.

5. The method of claim 1, wherein the swipe pattern is made by a finger of a user.

6. The method of claim 1, further comprising generating a plurality of predefined swipe patterns; and
and storing the predefined swipe patterns in a pattern library.

7. The method of claim 1, wherein the data is user login information.

8. A method for inputting data, comprising:
inputting data into an application on a device;
associating the data with a website and a pattern in the application on the device;
browsing to a recognized website on the device;
prompting the input of a pattern on a display on the device;
inputting a pattern into the device;
comparing the inputted pattern with at least one known pattern; and
populating data fields upon the successful input of a pattern.

9. The method of claim 9, wherein the data comprises a user name and password.

10. The method of claim 9, wherein the device is a mobile phone.

11. The method of claim 9, further comprising inputting the pattern onto the device using at least one of a touchscreen, mouse, stylus, trackball and keyboard.

12. The method of claim 9, wherein the pattern is input onto the device using a swiping motion on a touchscreen.

13. A system for inputting data onto a website, comprising:
a smart phone having a process and memory;
an application with an interface for inputting data, associates data with at least one of a plurality of patterns, and facilitates storage of the data; and
a website with data input fields that is compatible with the application,
wherein the application recognizes a website, the website provides a prompt to input a pattern, the application compares an inputted pattern with the plurality of patterns stored by the application and inputs the data associated with at least one of the plurality of patterns upon a successful comparison of the inputted pattern with the plurality of patterns stored by the application.

14. The system of claim 13, further comprising a touchscreen on the smart phone.

15. The system of claim 14, wherein the pattern is inputted to the website with the touchscreen on the smart phone.

16. The system of claim 13, wherein the data is security data used to access a protected website.

17. The system of claim 13, wherein the data is login information.
